(19) United States
(12) Patent Application Publication
(10) Pub. No.: US 2026/0351062 A1
(43) Pub. Date: Nov. 5, 2026

(54) Security system for a multi-unit complex

(71) Applicant: Massoud Mike Heidary, Gaithersburg, MD (US)

(72) Inventor: Massoud Mike Heidary, Gaithersburg, MD (US)

(21) Appl. No.: 18/831,448

(22) Filed: Jan. 30, 2025

(51) Int. Cl. G07C 9/00; G07C 9/23; G07C 9/27; G08B 13/196

(52) U.S. Cl. CPC G07C 9/00904; G07C 9/00571; G07C 9/23; G07C 9/27; G08B 13/19695

(57) ABSTRACT

A security system for a multi-unit complex with a entrance or door is disclosed. The system includes a security panel with a camera, keypad, microphone, speaker, motion sensor, a light, a light detector, and a processor. The processor is configured to keep the camera on a standby mode until a server receives a signal from a motion detector indicating a motion in front of the camera. The visitor enters the unit number of the host. The host upon receiving notification on a personal device, enters a first code using the personal device. The host also instructs the visitor to enter a second code into keypad of the security panel. The first code, the second code, the host information is verified by the server, and if the information matches the database of the server, the visitor is granted permission to enter the complex by unlocking the door.

### BACKGROUND OF THE INVENTION

Electronic security systems have become a popular way of securing and monitoring property. More and more electronic security systems are installed at locations of interest such as homes, offices, buildings and structures for the safety and protection of personnel and property.

### SUMMARY OF THE INVENTION

The present invention relates to a security system that provides security protection for a multi-unit complex and includes a security panel installed at an entrance or a door. The security panel includes a camera, keypad, microphone, speaker, a light, a light detector, a processor, a first interface for remote communication over a first network, a second interface for local communication over a second network. The security system further includes a motion sensor. The processor is configured to keep on a standby state until a signal indicating a motion in field of view of the camera by a visitor is received from a motion sensor over the second network. The security system receives power in a conventional manner. The system is designed to record an image of the visitor and stored in a memory bank.

### BRIEF DESCRIPTION OF THE DRAWINGS

FIG. 1: A schematic diagram of a security system for a multi-unit complex in accordance with the present invention. the security system includes a security panel close to or next to an entrance or door. The security system includes a camera, a microphone, a speaker, a light, a light sensor, and a key pad. In addition, the panel includes other electronic components shown in FIG. 2.

FIG. 2: Electronic components of the security system and how they are electrically connected among them. The components includes a camera, a microphone, a speaker, a light, a light sensor and a motion detector, a processor, a memory, the figure also shows electrical connection among various electronic components. The electronic components also includes a server and communication network among the processor, server and the resident or a host.

FIG. 3: A Schematic diagram of a door of the complex or building with a door lock and a visitor.

### DETAILED DESCRIPTION OF THE INVENTION

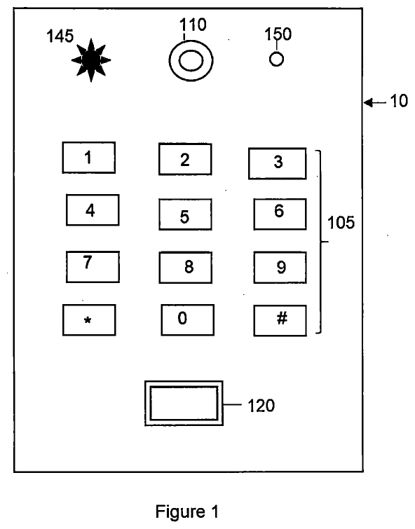

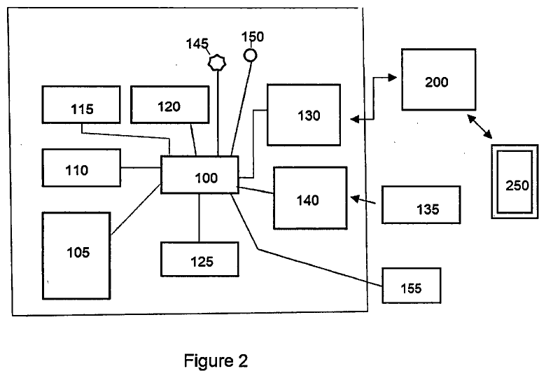

Referring to FIGS. 1-3, show various electronic components of the security system that includes the motion sensor 135 which detects presence of a visitor in the field of view of a camera 110. The motion sensor transmits the information to the processor 100 over a second network. The motion sensor 135 is shown to be separate from the security panel 10, but it could be incorporated into the security panel. The light detector 150 on the panel senses the intensity of light. The camera turns on when the light condition is at a preset intensity or better. The preset intensity of light for the camera 110 is set by the manufacturer. If the light detector detects the light above a preset intensity level then the light detector sends signal to the processor 100 to turn on the light 145, then the processor turns on the camera 110. Thus the camera 110 is able to capture the image or video of a visitor or a person standing in field of view and in proximity of the security panel under various light conditions.

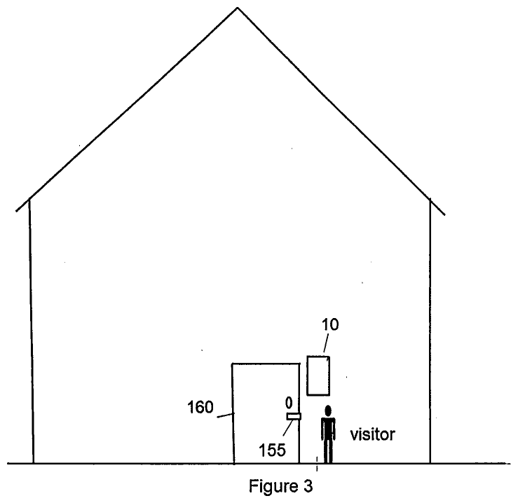

Each person (FIG. 3), upon acquiring a place or residence in the complex or a building is asked to register and download a software application (or an app) on their personal device 250, the app is specifically designed for the security complex. The app provides different functionality, such as uploading the information of the occupant or host on the server, including name, personal device telephone number, address including room number of the host. The server provides the host with a first and second access codes, the first access code being unique to the host. The app also allows receiving an image of the visitor on the personal device of the host in real time. When the visitor arrives at the security panel, the visitor enters the room number of the host in the security panel key board. The camera captures an image of the visitor and based on the room number entered, the security panel transmits the information to the server 200, which in turn connects the personal device 250 of the host. The host is notified of a visitor requesting permission to enter the complex (FIG. 3). The host using his/her personal device's keypad, enters a first code, which can be 3 or 4 digit alphanumeric code. The first code is recorded by the server. Using the personal device, the host also instructs the visitor over speaker 120 to enter a second code in the security panel's keypad. The system also has two way communication capability, so if the visitor has any question, the visitor could ask the question over microphone 115. The second code is different than the first code and is 3 or 4 digits long. The second code could be just numeric or alphanumeric code. The second code is recorded by the server. The database in the server 200 contains the information on the host, host's building and/or room number, previously assigned the first code, and the second code. When the host enters the first code and visitor enters the second code, the server verifies the entered first and second codes and records the host's building or room number, date, time and if the entered codes matches with the first and second codes in the database, the door lock 155 is unlocked and the visitor can open the door 160 to enter. The security system also records the video of the visitor and stores in memory 125. The video could be reviewed at a later date, if necessary.

### INDEX OF COMPONENTS

10—Security Panel
100—Processor
105—Keypad
110—Camera
115—Microphone
120—Speaker
125—Memory
130—First Interface
135—Motion Sensor
140—Second Interface
145—Light
150—Light Detector
155—Door Lock
160—Door
200—Server
250—Personal Device

1. A security system for a multi-unit complex with an entrance door, comprising:
a security panel, a server, a door lock;
the security panel comprises a keypad, a processor, a camera, a speaker, a light detector, a light, a memory, a first interface for remote communication over a first network, and a second interface for local communication over a second network; the keypad, the processor, the camera, the speaker, the light detector, the light, the memory, the first interface, and the second interface, are electrically connected;
wherein the light detector turns on the light upon detecting light level at or above preset intensity level,
wherein upon a visitor entering the room number of a host in the keypad of the security panel, the camera takes a picture of the visitor and the processor transmits the picture of the visitor to the host over the first network,
wherein the host enters a first code into a personal device, and provides the visitor a second code over the first network, the host also instructs the visitor to enter the second code into keypad of the security panel;
the room number, date, time, first code, second code, the visitor's picture and video activity of the visitor are recorded in the server;
wherein, if the first code, second code and the host room number matches the database stored on the server, the server sends a signal to the processor in the security panel to unlock the door.

2. The security system according to claim 1, wherein the first code is 3 or 4 digit alphanumeric code, and the second code is 3 or 4 digit long; the second code being different than the first code.

3. The security system according to claim 1, wherein the security system includes a motion sensor which detects presence of a visitor in the field of view of the camera.

4. The security system according to claim 3, wherein the processor is configured to keep the camera on a standby mode until a signal indicating a presence of the visitor is received from the motion sensor over the second network, and upon receipt of the signal indicating presence of the visitor, the camera is turned on.

5. The security system according to claim 4, wherein the security system records the video of the visitor and stores in a memory.
